(19) United States
(12) Patent Application Publication
(10) Pub. No.: US 2008/0018118 A1
(43) Pub. Date: Jan. 24, 2008

(54) Locking apparatus and method of use

(76) Inventor: George G. Schultz, Garrett, IN (US)

Correspondence Address: Galasso & Associates, LP, P.O. Box 26503, Austin, TX, 78755-0503, US

(21) Appl. No.: 11/489,955

(22) Filed: Jul. 20, 2006

(51) Int. Cl. E05C 19/00; E05C 21/02

(52) U.S. Cl. 292/259 R

(57) ABSTRACT

A locking apparatus and method of use are provided. In one form, a locking apparatus includes a horizontal member including hinges and a vertical member bisecting the horizontal member. The locking apparatus includes a fastening mechanism operable to secure the horizontal member to the aperture. The locking apparatus also includes a handle on the vertical member to allow the locking apparatus to be manipulated by the user without stooping and a clasp along the aperture enabling storage of the folded apparatus. The locking apparatus further includes a pressure sensor and a speaker operable to sound an alarm if someone attempts to force open the locking apparatus.

### FIELD OF THE DISCLOSURE

The invention generally relates to locks, and more particularly to a locking us for a sliding aperture and method of use.

### BACKGROUND

Humans have a strong desire to be in the presence of a visually attractive environment, as witnessed by the proliferation of homes and vacation destination boasting beautiful views of rivers, lakes, oceans, and mountains. Even when people are not afforded one of these dramatic views at their residence, they often spend large sums of money creating beautiful landscaping in their back yard and around their home. Unfortunately, windows provide views of the landscape, but usually do not allow easy ingress and egress and doors often obstruct the view.

Luckily, sliding apertures such as sliding glass windows were created, providing a panoramic view of the exterior of the home, while allowing occupants and guests to enter and exit the house via the sliding door. The locks that come with these doors do not provide enough security for many users, prompting them to buy sliding door locks, usually primarily consisting of a bar mounted to the side of the door, and lowered across the middle of the door, which blocks the view the user worked so hard to obtain. Another option is to mount the lock at the bottom of the door to provide a clear view, but this requires the user to bend and stoop every time he or she operates the lock, which can cause joint, ligament, and spine damage. Also, conventional sliding door locks are an all or nothing affair—either the door is open and security is compromised or the door is closed and no air or pets can pass. What is needed is a way to lock a sliding door without requiring the user to stoop to operate it without obstructing the view through the door.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a front perspective view of a locking apparatus for a sliding aperture in accordance with one aspect of the invention; and

FIG. 2 illustrates a front perspective view of a clasping mechanism for a locking apparatus for a sliding aperture in accordance with one aspect of the invention; and

FIG. 3 illustrates a locking apparatus for a sliding aperture in a locked position and a coupling of the locking apparatus to a clasping mechanism in accordance with one aspect of the invention.

### DESCRIPTION

A locking apparatus for a sliding aperture and method of use are provided. In one form, a locking apparatus for a sliding aperture includes a horizontal member and a vertical member including a first termination and a second termination. The locking apparatus further includes the vertical member joining and substantially bisecting the horizontal member. The locking apparatus includes hinges at the intersection of the horizontal member and the vertical member that create a first hinged section of the horizontal member and a second hinged section of the horizontal member. The hinges allow the horizontal sections to fold flat against the vertical member, allowing the locking apparatus to be easily moved for use with another sliding aperture. The vertical member includes clasps to secure the folded hinged sections of the horizontal member. The second hinged horizontal section further includes a third hinge, enabling a portion of the horizontal member between the intersection of the vertical member and the termination of the horizontal member to fold up to allow a partial opening of the aperture for airflow or an insertion of a panel including a standard pet door. The locking apparatus further includes a fastening mechanism at the termination of the first hinged horizontal section allowing the locking apparatus to be secured to the aperture. In one embodiment, the fastening mechanism is removable, enabling portability of the locking apparatus. The locking apparatus includes a clasping mechanism coupled to the aperture, operable to clasp and store the folded locking apparatus. The locking apparatus further includes a pressure sensor and speaker along the horizontal member and a handle along the vertical member. The horizontal member may be placed along the bottom aperture allowing for an unobstructed view through the aperture, and the handle may allow operation of the locking mechanism without requiring the user to bend over, saving wear and tear on the user's back and joints and enabling disabled users to utilize the locking mechanism.

According to another aspect of the invention, a locking apparatus for use with a sliding aperture is disclosed. The apparatus includes a horizontal member including a first termination and a second termination, and a vertical member including a first termination and a second termination. The vertical member is joined to the horizontal member at the first termination of the vertical member, substantially bisecting the horizontal member. The locking apparatus further includes a fastening mechanism at the first termination of the horizontal member, a handle mounted to the second termination of the vertical member, and a clasping mechanism mounted to the aperture. The handle may be used to lock and unlock the apparatus without requiring the user to bend over. The clasping mechanism can be used to store the locking apparatus when not in use. The apparatus further includes an audible alarm and a pressure sensitive switch along the horizontal member. The sensor may detect a forced opening of the locking apparatus and trigger the audible alarm. The horizontal and vertical members may be made from a variety of materials and in one embodiment comprise aluminum. The handle may be made from a variety of materials and in one embodiment comprises rubber.

According to a further aspect of the invention, a locking apparatus for a sliding aperture and method of use are provided. The locking apparatus includes a horizontal member including a first termination and a second termination, and a vertical member including a first termination and a second termination. The vertical member bisects the horizontal member at the first termination of the vertical member. The locking apparatus further includes hinges at the intersection of the horizontal member and vertical member, creating a first hinged section of the horizontal member and a second hinged section of the horizontal member. The horizontal member includes a fastening mechanism at the termination first hinged section of the horizontal member. The fastening mechanism may be used to secure the locking apparatus to the aperture. The apparatus further includes a pressure sensor and speaker along the second hinged section of the horizontal member. The vertical member includes a handle mounted to the second termination of the vertical member. The locking apparatus includes a clasping mechanism mounted to the aperture that can grasp and store the locking apparatus when folded at the hinges along the horizontal member. The vertical member further includes a height of at least twenty (20) inches and no more than forty (40) inches, a width of at least one half (½) inch and no more than four (4) inches, and a thickness of at least one eighth (⅛) inch and no more than one (1) inch. The horizontal member further includes a length of at least twenty-four (24) inches and no more than sixty (60) inches, a width of at least one half (½) inch and no more than four (4) inches, and a thickness of at least one eighth (⅛) inch and no more than one (1) inch.

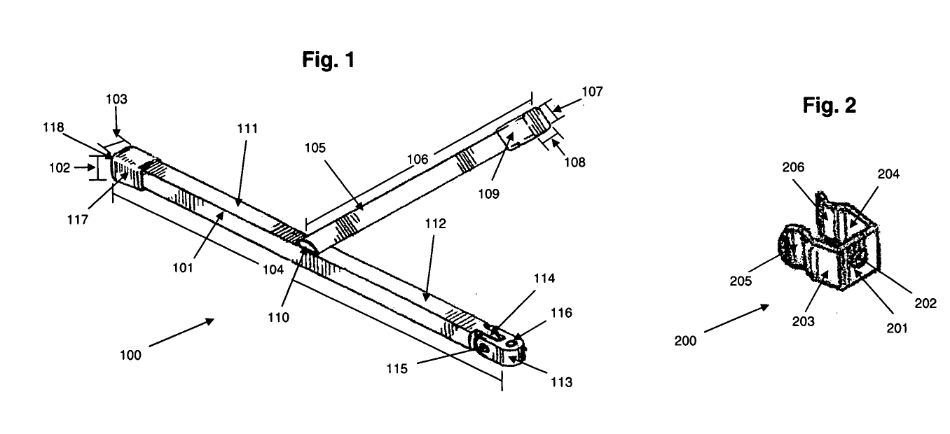

FIG. 1 illustrates a front perspective view of a locking apparatus for a sliding aperture in accordance with one aspect of the invention. The locking apparatus, illustrated generally at 100, includes horizontal member 101 generally shaped as a rectangle. Horizontal member 101 includes a height 102 of at least one half (½) inch and no more than four (4) inches, a thickness 103 of at least one eighth (⅛) inch and no more than four (4) inches, and a length 104 of at least twenty-four (24) inches and no more than sixty (60) inches. Locking apparatus 100 further includes vertical member 105, generally shaped as a rectangle and joined to horizontal member 101, substantially bisecting horizontal member 101. Vertical member 105 includes a length 106 of at least twenty (20) inches and no more than forty (40) inches, a width 107 of at least one half (½) inch and no more than four (4) inches, and a thickness 108 of at least one eighth (⅛) inch and no more than one (1) inch.

Vertical member 105 includes handle 109. Handle 109 allows the user to operate apparatus 100 from a standing position, eliminating the need to stoop to lock or unlock the apparatus, saving wear and tear on the user's back and joints, and allowing users with physical disabilities to use the apparatus. Vertical member 105 substantially bisects horizontal member 101 at hinge 110. Hinge 110 allows vertical member 105 the range of motion needed to allow vertical member 105 to be used to place horizontal member 101 into a locked position and an unlocked position. Hinge 110 further allows vertical member 105 to be secured to a clasping mechanism mounted to the aperture (not expressly shown) when in use. Locking apparatus 100 may include a plurality of hinges generally located at 110 (not expressly shown), giving horizontal member 101 a first horizontal hinged section 111 and a second horizontal hinged section 112. First horizontal hinged section 111 and second horizontal hinged section 112 may be folded flat against vertical member 105, and may be coupled to vertical member 105 via a clasping mechanism (not expressly shown). First horizontal hinged section 111 may include an additional hinge (not expressly shown), allowing the first horizontal hinged section to pivot, allowing a partial opening of the sliding aperture without removing locking apparatus 100 from a locked position. This partial opening of the sliding aperture can allow fresh air to circulate without diminishing the security afforded by the locking apparatus. The partial opening of the sliding aperture allows the insertion of a panel into the aperture. The panel may include a pet door, allowing pet ingress and egress without sacrificing the security of having the locking mechanism in a locked position in the sliding aperture.

Horizontal member 101 further includes fastening mechanism 113. Fastening mechanism 113 includes hinge 114, attaching fastening mechanism 113 to horizontal member 101 with a first connecting mechanism 115. Hinge 114 allows horizontal member 101 to be placed in a horizontal position, illustrated generally at 100, locking the sliding aperture. Hinge 114 further allows horizontal member 101 to be moved to a vertical position (not expressly shown), allowing use of the sliding aperture. Fastening mechanism 113 further includes second connecting mechanism 116, enabling locking apparatus 100 to be fastened to the aperture (not expressly shown).

Horizontal member 101 further includes pressure sensor 117 and speaker 118 located along horizontal member 101. Pressure sensor 117 may detect an attempted opening of the locked aperture (not expressly shown) when locking apparatus 100 is in a locked position. In one embodiment, upon sensing the attempted opening, pressure sensor 117 triggers speaker 118, providing an audible alarm to deter the attempted trespasser and alerting occupants and neighbors to the attempted trespass. In another embodiment, pressure sensor 117 is integrated with a security system, providing an alert to the monitors of the security system of the attempted trespass. In a further embodiment, pressure sensor 117 is integrated with a warning system operable to alert the owner over a distance that a forced opening was attempted.

In one embodiment, locking apparatus 100 is primarily formed of aluminum. In another embodiment, locking apparatus 100 may primarily be formed of a variety of materials, including but not limited to steel, wood, plastic, various polymers, or any material that contains the strength requirements to keep a sliding aperture from being opened when locking apparatus 100 is applied in the locking position. In one embodiment, locking apparatus 100 is formed from materials with the ability to take and retain a color, allowing locking apparatus 100 to be provided in an infinite variety of colors and patterns. In one embodiment, handle 109 is composed of plastic. In another embodiment, handle 109 is composed of rubber or other polymer. In one embodiment, handle 109 has the ability to take and retain a color, allowing handle 109 to be provided in an infinite variety of colors and patterns.

During use, a user mounts locking apparatus 100 to an aperture (not expressly shown) by attaching fastening mechanism 113 to the bottom of an opening of the stationary panel of the sliding aperture (not expressly shown). In one embodiment, fastening mechanism 113 attaches locking apparatus 100 to the aperture (not expressly shown) in a non-removable fashion by inserting a fastener (not expressly shown) through second connecting mechanism 116 into the bottom of the sliding aperture (not expressly shown). To lock the sliding aperture in a closed position, the user grasps handle 109, removing vertical member 105 from a clasping mechanism (not expressly shown) attached to the side of the sliding aperture (not expressly shown). While holding handle 109, the user then lowers apparatus 100 into a locked position generally illustrated at 100 as hinge 110 articulates to allow horizontal member 101 to lower fully into a horizontal position at the bottom of the sliding aperture (not expressly shown) with pressure sensor 117 abutting the non-stationary panel of the sliding aperture (not expressly shown), preventing the sliding aperture panel (not expressly shown) from opening. When the user wishes to open the sliding aperture (not expressly shown), the user grasps handle 109 while the user remains in a standing position and raises locking apparatus 100 to a vertical position by manipulating vertical member 105 articulating hinge 110 and moving horizontal member 101 to a vertical position, attaching locking apparatus 100 to a clasping mechanism (not expressly shown). In one embodiment, horizontal member 101 includes a plurality of hinges allowing a portion of horizontal member 101 to articulate while the remainder of horizontal member 101 remains in a locked position, allowing the user to partially open the aperture to allow air circulation. The user may further insert a panel including a pet door into the partially opened aperture. The partial opening still provides security by keeping the aperture from being fully opened. Being able to manipulate locking apparatus 100 while a user is in a standing position by manipulating vertical member 105 with handle 109 prevents the user from having to bend over. This helps prevent repetitive stress injuries to the user's spine, joints, and ligaments. Having horizontal member 101 attached to the bottom of the sliding aperture (not expressly shown), prevents interference with the user's view through a transparent sliding aperture (not expressly shown), allowing the user to fully enjoy the view presented outside the structure (not expressly shown). In another embodiment, fastening mechanism 113 is easily removable from the aperture (not expressly shown), allowing locking apparatus 100 to be portable.

FIG. 2 illustrates a front perspective view of a clasping mechanism for use with a locking apparatus for a sliding aperture in accordance with one aspect of the present invention. A clasping mechanism for use with a locking apparatus for use with a sliding aperture is illustrated generally at 200. Clasping mechanism 200 includes front facing 201 and aperture 202. A fastener (not expressly shown) may be inserted through aperture 202 for the purpose of securing clasp 200 to a side of a sliding aperture (not expressly shown). Clasping mechanism 200 further includes a first front section 203 and a second front section 204 contiguous to and perpendicular to front facing 201. First front section 203 and second front section 204 abut front facing 201 on opposing sides of front section 204. Clasping mechanism 200 further includes first indented section 205 and second indented section 206. First indented section 205 abuts first front section 203 and contains a concave section curving inward toward second indented section 206. Second indented section 206 abuts first front section 204 and contains a concave section curving inward toward first indented section 205.

During use, a user attaches clasping mechanism 200 to a vertical side of a sliding aperture (not expressly shown) by inserting a fastener (not expressly shown) through aperture 202 and into the vertical side of the sliding aperture (not expressly shown). Clasping mechanism 200 is installed with front facing 201 flush against the vertical side of the sliding aperture (not expressly shown) so that first front section 203 and second front section 204 extend away from the side of the vertical side of the sliding aperture (not expressly shown) where clasping mechanism 200 is mounted. As the user inserts the vertical member of a locking apparatus for a sliding aperture (not expressly shown) into clasping mechanism 200, first indented section 205 and second indented section 206 flex slightly away from the vertical member (not expressly shown), allowing the vertical member (not expressly shown) to move past first indented section 205 and second indented section 206 and flush against inside first front section 203, second front section 204, and front facing 201. Once the user has moved the vertical member (not expressly shown) past first indented section 205 and second indented section 206, first indented section 205 and second indented section 206 flex back to their original positions, securing the vertical member (not expressly shown). In one embodiment, clasping mechanism 200 is made of aluminum. In another embodiment, clasping mechanism 200 is made of materials including but not limited to steel, plastic, and polyurethane. The material of clasping mechanism 200 will be strong and flexible enough to allow repeated insertions and removals of a locking apparatus for a sliding aperture (not expressly shown), without clasping mechanism 200 losing strength or flexibility.

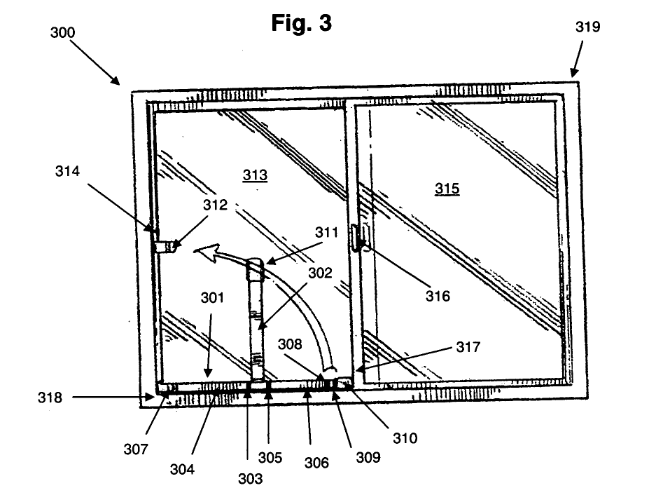

FIG. 3 illustrates side perspective view of a locking apparatus for a sliding aperture affixed to the sliding aperture in a locked position and a coupling of the locking apparatus to a clasp in accordance with one aspect of the invention. A locking apparatus for a sliding aperture affixed to the sliding aperture in a locked position is illustrated generally at 300. Locking apparatus 300 includes horizontal member 301 and vertical member 302, where vertical member 302 substantially bisects horizontal member 301 to form the shape of an upside down “T.” Horizontal member 301 includes a first hinge 303, forming a first horizontal hinged section 304. First horizontal hinged section 304 may fold at first hinge 303, allowing first horizontal hinged section 304 to abut vertical member 302. Horizontal member 301 further includes a second hinge 305, forming a second horizontal hinged section 306. Second horizontal hinged section 306 may fold at hinge 305, allowing second horizontal hinged section 306 to abut vertical member 302. First horizontal hinged section 304 and second horizontal hinged section 306 may be fastened to vertical member 302 when abutting vertical member 302 by a set of fasteners attached to vertical member 302 (not expressly shown). Horizontal member 301 is affixed to sliding aperture 315 with fastening mechanism 307, located at the termination of first horizontal hinged section 304, opposite termination of horizontal hinged section 304 at first hinge 303. Horizontal member 301 further includes third hinge 308, forming third horizontal hinged section 309.

Sliding aperture 319 includes a first sliding aperture panel 313 and a second sliding aperture panel 315. Sliding aperture 319 further includes bottom horizontal aperture section 318. First sliding aperture panel 313 further includes first vertical side 314. Second sliding aperture panel 315 further includes first vertical side 317. Third horizontal hinged section 309 may articulate to allow a partial opening of first sliding aperture panel 315 to allow fresh air into the structure (not expressly shown). Horizontal member 301 includes a pressure switch and speaker 310 located along horizontal member 301 that will sound an audible alarm if a forced entry of first sliding aperture panel 315 is attempted while locking apparatus 300 is in the locked position, illustrated generally at 300. In one embodiment, pressure switch and speaker 310 may detect and sound an alarm for a breaking of first sliding aperture panel 315 or second sliding aperture panel 313 in addition to detecting an attempted forced opening of first sliding aperture panel 315.

Vertical member 302 further includes handle 311 at the termination of vertical member 302 opposite the termination of vertical member 302 bisecting horizontal member 301. Handle 311 may be composed of a variety of materials, including but not limited to rubber and plastic. Locking apparatus 300 includes clasping mechanism 312, generally attached to a first vertical side 314 of second sliding aperture panel 313. When locking apparatus 300 is folded at first hinge 303 and second hinge 305, it may be stored by fastening locking apparatus 300 to clasping mechanism 312. Aperture handle 316 is attached to first sliding aperture panel 315 and may be used to open and close first sliding aperture panel 315.

During use, a user wishing to prevent first sliding aperture panel 315 from being opened will install locking apparatus 300 along bottom horizontal aperture section 318 of sliding aperture 319 by attaching fastening mechanism 307 to bottom horizontal aperture section 318. In one embodiment, fastening mechanism 307 is attached to bottom horizontal aperture section 318 by inserting a fastener such as a screw, bolt, or nail (not expressly shown) through fastening mechanism 307 and into bottom horizontal aperture section 318. In another embodiment, fastening mechanism 307 may be inserted and removed with only the user's hands, allowing easy insertion and removal of locking apparatus 300, providing portability.

To lock first sliding aperture panel 313 and second sliding aperture panel 315 in a closed position, the user grasps handle 311 on vertical member 302 and manipulates locking apparatus 300 to place horizontal member 301 in a horizontal position, with pressure switch and speaker 310 abutting first vertical side 317 of first sliding aperture panel 315, securing first sliding aperture panel 315 and second sliding aperture panel 313 in a closed position. If the user wishes to allow fresh air to enter the structure while maintaining the security afforded by having locking apparatus 300 in a locked position, the user may articulate third horizontal hinged section 309 at third hinge 308, allowing first sliding aperture panel 315 to partially open, providing enough space to provide air circulation, but not enough space for an intruder to enter. In one embodiment, third hinge 308 is placed in a manner to allow third horizontal hinged section 309 to be large enough to provide a large enough opening for insertion of a panel containing a pet door (not expressly shown). This provides the user with the ability to control a pet's ingress and egress from the structure (not expressly shown) by inserting and removing the panel with the pet door (not expressly shown) as the user desires, without losing the security afforded by having locking apparatus 300 in a locked position.

To open first sliding aperture panel 315, the user grasps handle 311 and pulls handle 311 and vertical member 302 toward clasping mechanism 312, causing articulation of first horizontal hinged section 304 at first hinge 303 and second horizontal hinged section 306 at second hinge 305, causing first horizontal hinged section 304 and second horizontal hinged section 306 to abut vertical member 302. In one embodiment, first horizontal hinged section 304 and second horizontal hinged section 306 are kept in a vertical position by attaching to fastening mechanisms on vertical member 302 (not expressly shown). Once the user inserts vertical member 302 into clasping mechanism 312, the user may open and close first sliding aperture 315 by using aperture handle 316.

In one embodiment, sliding aperture 319 represents a sliding glass door in a house. In another embodiment, sliding aperture 319 is door in a structure including but not limited to a shed, an office building, or a boat. In another embodiment, sliding aperture 319 is a window in a structure including but not limited to a house, shed, office building, boat, or vehicle.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A locking apparatus for a sliding aperture comprising:
a horizontal member;
a vertical member including a first termination and a second termination, the first termination of the vertical member joined to the horizontal member and substantially bisecting the horizontal member at the first termination of the vertical member;
a handle at the second termination of the vertical member;
a first hinge at the intersection of the horizontal member and the vertical member, operable to form a first hinged section of the horizontal member;
a second hinge at the intersection of the horizontal member and the vertical member, operable to form a second hinged section of the horizontal member;
a fastening mechanism at the termination of the first hinged section of the horizontal member;
a pressure sensor and speaker along the second hinged section of the horizontal member; and
a clasping mechanism mounted to a vertical section of the aperture.

2. The locking apparatus of claim 1, wherein the second hinged section of the horizontal member includes a hinge between the intersection of the vertical member and horizontal member and the termination of the second hinged section of the horizontal member, operable to create a third hinged section of the horizontal member.

3. The locking apparatus of claim 1, wherein the third hinged section of the horizontal member is operable to allow a partial opening of the aperture.

4. The locking apparatus of claim 1, wherein the third hinged section of the horizontal member is operable to allow insertion of a panel including a standard pet door into the aperture without removal of the locking apparatus from the aperture.

5. The locking apparatus of claim 1, wherein the first hinge and the second hinge are operable to allow the first hinged section of the horizontal member and the second hinged section of the horizontal member to fold against the vertical member.

6. The locking apparatus of claim 1, wherein the vertical member includes a clasping means operable to secure the folded hinged sections of the horizontal member to the vertical member.

7. The locking apparatus of claim 1, wherein the folded locking apparatus may be secured to the clasp, operable to provide storage of the locking apparatus and full use of the sliding aperture.

8. The locking apparatus of claim 1, wherein the fastening mechanism may be removed from the aperture, operable to allow the locking apparatus to be moved for use with another aperture.

9. The locking apparatus of claim 1, wherein the horizontal member is used along the bottom of the aperture, operable to allow an unobstructed view through the aperture.

10. The locking apparatus of claim 1, wherein the handle is operable to allow the apparatus to be locked or unlocked while the user is in a standing position.

11. A locking apparatus for a sliding aperture comprising:
a horizontal member including a first termination and a second termination;
a vertical member including a first termination and a second termination, the first termination of the vertical member substantially bisecting the horizontal member;
a fastening mechanism at the first termination of the horizontal member operable to secure the locking apparatus to the aperture;
a handle mounted to the second termination of the vertical member, and;
a clasping mechanism mounted to the aperture operable to grasp and store the locking apparatus.

12. The locking apparatus of claim 11, further comprising an audible alarm located along the horizontal member.

13. The locking apparatus of claim 11, further comprising a pressure-sensitive sensor located along the horizontal member.

14. The locking apparatus of claim 13, wherein the sensor is operable to detect an attempted opening of the aperture.

15. The locking apparatus of claim 14, wherein the sensor triggers the audible alarm upon detecting an opening of the aperture.

16. The locking apparatus of claim 11, wherein the horizontal and vertical members further comprise aluminum.

17. The locking apparatus of claim 11, wherein the handle comprises rubber.

18. A locking apparatus for a sliding aperture comprising:
a horizontal member including a first termination and a second termination;
a vertical member including a first termination and a second termination, the first termination of the vertical member substantially bisecting the horizontal member;
a first hinge substantially at the intersection of the horizontal member and the vertical member, operable to form a first hinged section of the horizontal member;
a second hinge substantially at the intersection of the horizontal member and the vertical member, operable to form a second hinged section of the horizontal member;
a fastening mechanism at the termination of the first hinged section of the horizontal member operable to secure the locking apparatus to the aperture;
a handle mounted to the second termination of the vertical member;
a pressure sensor mounted to the second hinged section of the horizontal member;
a speaker along the second hinged section of the horizontal member; and
a clasping mechanism mounted to the aperture operable to grasp the locking apparatus.

19. The locking apparatus of claim 18, wherein the vertical member includes:
a length of at least twenty (20) inches and no more than forty (40) inches;
a width of at least one half (½) inch and no more than four (4) inches; and
a thickness of at least one eighth (⅛) inch and no more than one (1) inch.

20. The locking apparatus of claim 18 wherein the horizontal member includes:
a length of at least twenty-four (24) inches and no more than sixty (60) inches;
a height of at least one half (½) inch and no more than four (4) inches; and
a thickness of at least one eighth (⅛) inch and no more than four (4) inches.
